(19) United States
(12) Patent Application Publication
(10) Pub. No.: US 2014/0224252 A1
(43) Pub. Date: Aug. 14, 2014

(54) HARNESS FOR BREATING APPARATUS

(71) Applicants: Daniel Martin, Gateshead (GB); Jame Farnaby, Newcastle-Upon-Tyne (GB); Paul Townsend, Cramlington (GB); Gordon Wrigley, Newcastle-Upon-Tyne (GB); David Cheesman, Bedlington (GB)

(72) Inventors: Daniel Martin, Gateshead (GB); Jame Farnaby, Newcastle-Upon-Tyne (GB); Paul Townsend, Cramlington (GB); Gordon Wrigley, Newcastle-Upon-Tyne (GB); David Cheesman, Bedlington (GB)

(73) Assignee: Draeger Safety UK Limited, Blyth (Northumberland) (GB)

(21) Appl. No.: 14/005,712

(22) PCT Filed: Feb. 23, 2012
(86) PCT No.: PCT/GB12/50414

§ 371 Date: Mar. 18, 2014

(30) Foreign Application Priority Data
Mar. 18, 2011 (GB) 1104626.5

(51) Int. Cl. A62B 9/04; A62B 7/02

(52) U.S. Cl. CPC A62B 9/04; A62B 7/02
USPC 128/205.22

(57) ABSTRACT

There is disclosed a harness for breathing apparatus, the harness arranged to support a plurality of cylinders of breathable gas side-by-side. The harness comprises a plurality of longitudinally extending cylinder channels arranged side-by-side, each cylinder channel having a rear wall and open at least partially along its length and arranged to accommodate a cylinder. Adjacent cylinder channels are laterally separated by a longitudinally extending channel side wall that in use is disposed between adjacent cylinders.

The invention relates to a harness for breathing apparatus which is capable of supporting a plurality of cylinders of breathable gas side-by-side.

Self-contained breathing apparatus (SCBA) typically comprises a harness for supporting a single cylinder of breathable gas on the back of a user, a pressure reducer for reducing the pressure of the gas within the cylinder, and a fluid supply line for supplying the breathable gas to the user.

Whilst such an arrangement is suitable for many applications, the cylinder is usually relatively heavy and of a large diameter. The cylinder therefore usually projects from the user's back and may present a snagging risk when the user is required to crawl or climb through confined spaces. Further, the centre of gravity of the breathing apparatus is located behind and away from the user's back and therefore has a tendency to pull the user backwards, reducing their stability.

It may therefore be desirable to provide a lower-profile breathing apparatus set.

In a previously considered arrangement a plurality of small-diameter cylinders are located side-by-side in a fabric bag that can be worn on the back of a user. This may have the disadvantage that the breathing apparatus is not particularly stable or comfortable to wear. Further, there may be friction between adjacent cylinders which may cause damage to the cylinders.

It may therefore be desirable to provide an improved harness for breathing apparatus for carrying a number of cylinders of breathable gas side-by-side which provides increased protection to the cylinders.

In a broad aspect the invention relates to a plurality of cylinder channels arranged side-by-side and each open at least partially along its length, with a side wall separating adjacent cylinder channels which in use is disposed between adjacent cylinders.

According to an aspect of the invention there is provided a harness for breathing apparatus, the harness arranged to support a plurality of cylinders of breathable gas side-by-side (or laterally spaced), the harness comprising a plurality of longitudinally extending cylinder channels arranged side-by-side (or laterally spaced), each cylinder channel having a rear wall and open at least partially along its length and arranged to accommodate a cylinder, wherein adjacent cylinder channels are laterally separated by a longitudinally extending channel side wall that in use is disposed between adjacent cylinders. The cylinder channels may be open along their entire length so as to facilitate simple insertion of cylinders into the channels. The cylinder channels may be flexible or rigid. The cylinder channels may be arranged to accommodate a single cylinder. In some arrangements a channel side wall may be arranged to be disposed between adjacent cylinders and may be disposed along the entire length of the cylinders so as to protect them.

The or each channel side wall may be provided with a retaining means which in use is arranged to inhibit the withdrawal of the or each channel side wall from between adjacent cylinders. The retaining means may be any suitable device or mechanism. For example, the retaining means may be a toggle, strap, band, or projection.

The or each channel side wall may be provided with a conduit retainer such that in use a conduit can be attached to the channel side wall so as to inhibit the withdrawal of the channel side wall from between adjacent cylinders. The conduit retainer may be a clip or channel. The or each conduit retainer may be located at the front of the channel side wall so that the conduit can be attached to the channel side wall in front of the cylinders. The or each conduit retainer may comprise a conduit retainer channel that longitudinally extends with the channel side wall and within which a conduit can be retained. The conduit retainer channel may be closed along its length, or may be openable or partially open along its length. The or each conduit retainer channel may be coextensive with the respective channel side wall. The or each conduit retainer channel may be openable along its length so that a conduit can be inserted into and removed from the conduit retainer channel.

The rear walls and/or the or each channel side wall may comprise a layer of fabric. The rear walls may have a curved profile that corresponds to the shape of the cylinder. The rear walls and the or each channel side wall may be formed from a continuous layer of fabric or from a plurality of sheets or layers of fabric attached together such as by stitching. The or each channel side wall may comprise a double layer of fabric. The fabric may be folded back on itself to form the side wall. The or each double layer of fabric may be stitched together along a first longitudinally extending line between the channel side wall and an adjacent pair of rear walls. This stitched line may form the base of the side walls. The or each double layer of fabric may be stitched together along a second longitudinally extending line which is rearward of a forward-facing edge of the channel side wall,

The stitching along the second longitudinally extending line may form, of may form at least part, of a conduit retainer channel.

The harness may further comprise a cover that can be moved between at least a closed configuration in which in use the cylinders are covered and an open configuration in which in use the cylinders are at least partially exposed.

The harness may further comprise upper and lower longitudinally spaced housings arranged to retain upper and lower portions of each cylinder respectively. The plurality of cylinder channels may extend between the upper and lower housings. The upper and lower longitudinally spaced housings may be coupled (or attached) together by a longitudinally extending back member. The longitudinally extending back member may comprise, define or form the plurality of cylinder channels. The back member may comprise a layer of fabric.

The harness may further comprise left and right shoulder straps. The harness may further comprise a waist belt.

There may be at least two, at least three or at least four cylinder channels.

The cylinders may have a diameter of between 50-150 mm, between 50-100 mm, or between 75-100 mm, for example. The length of the cylinders may be between 500- 1000 mm, between 600-900 mm, or between 700-800 mm, for example.

The invention also concerns a breathing apparatus set comprising: a harness in accordance with any statement herein; and a plurality of cylinders of breathable gas supported by the harness, wherein each cylinder is disposed in a cylinder channel.

The cylinders may have an outermost layer of carbon-fibre. The cylinders may have upper and lower cylinder portions in fluid communication through a fluid joint. The fluid joint may be flexible.

The invention may comprise any combination of the features and/or limitations referred to herein, except combinations of such features as are mutually exclusive.

Embodiments of the invention will now be described, by way of example, with reference to the accompanying drawings, in which:

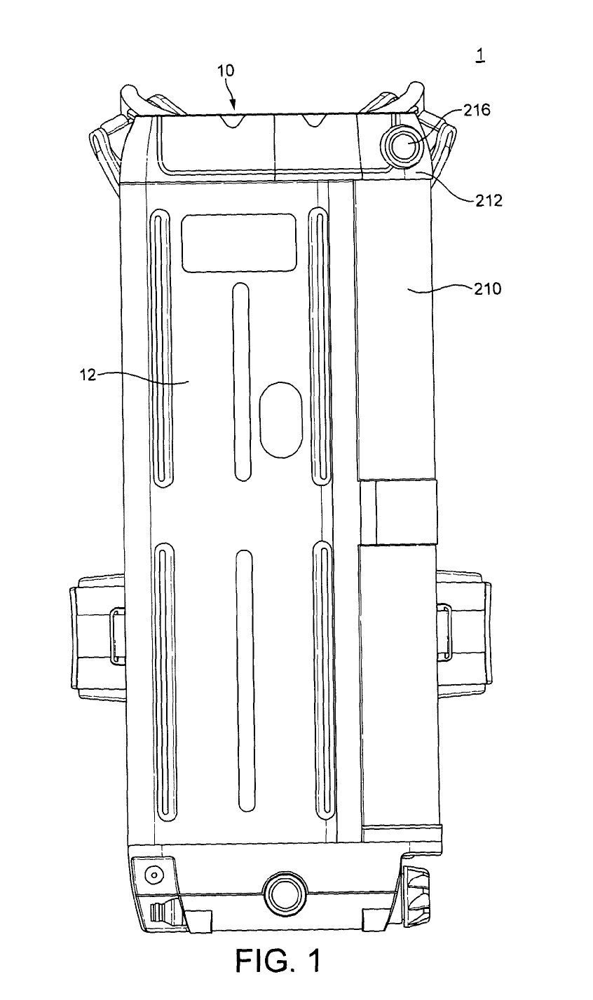

FIG. 1 schematically shows a front view of a breathing apparatus set;

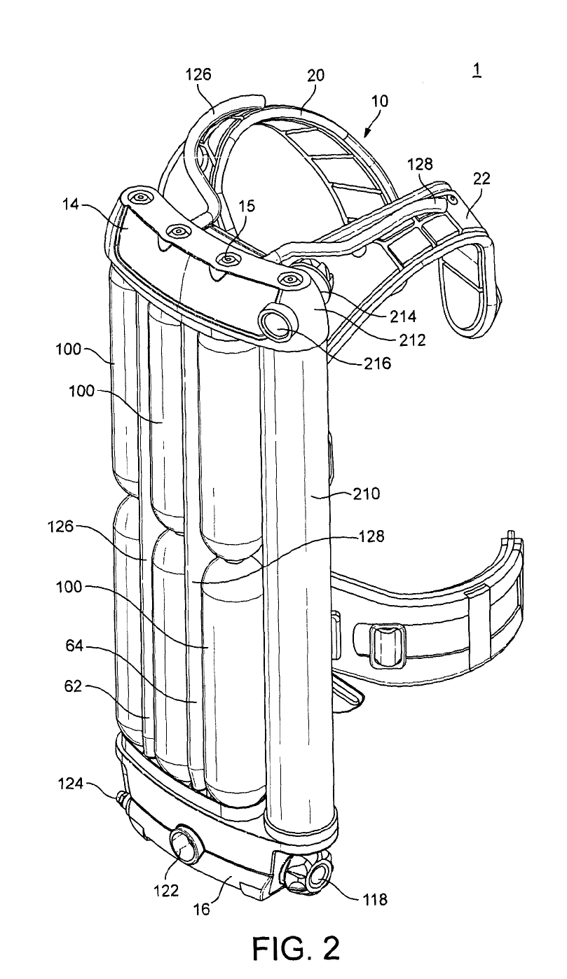

FIG. 2 schematically shows a perspective view of the breathing apparatus set of FIG. 1 with the cover removed;

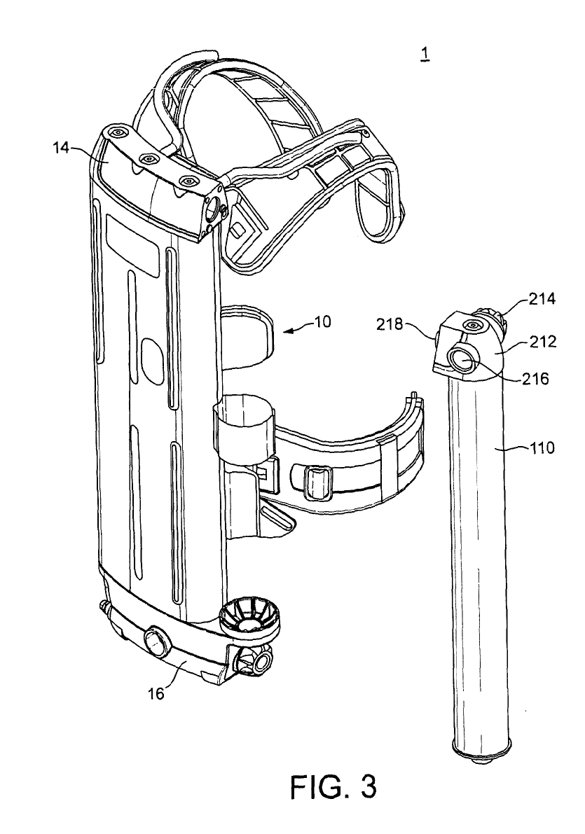

FIG. 3 schematically shows the breathing apparatus set of FIG. 2 with the auxiliary cylinder module removed;

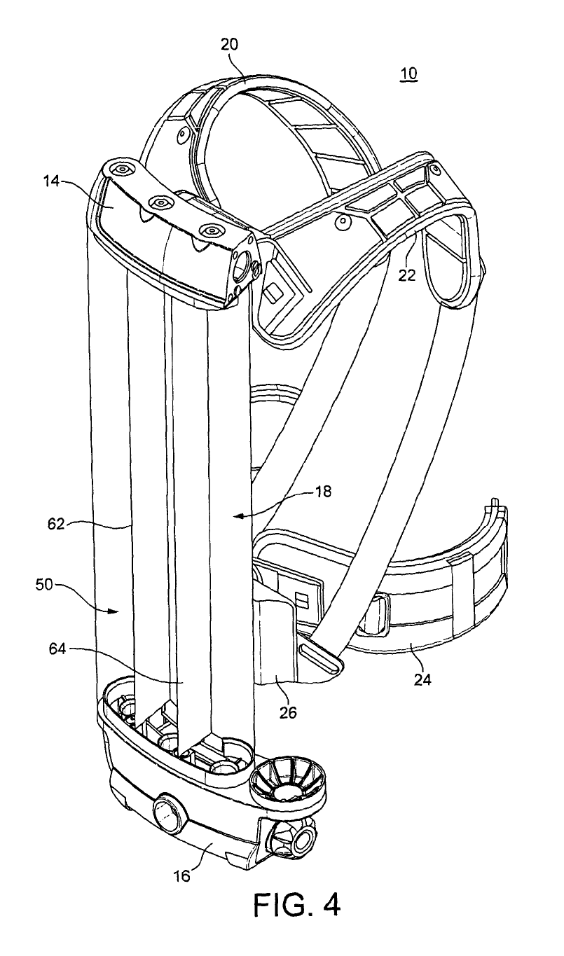

FIG. 4 schematically shows a perspective view of the harness of the breathing apparatus set of FIG. 1;

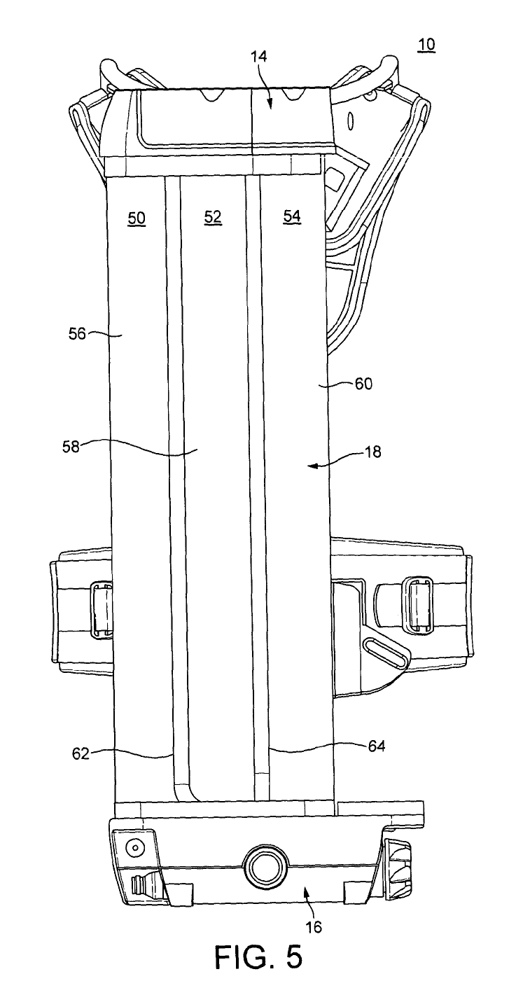

FIG. 5 schematically shows a front view of the harness of the breathing apparatus set of FIG. 1;

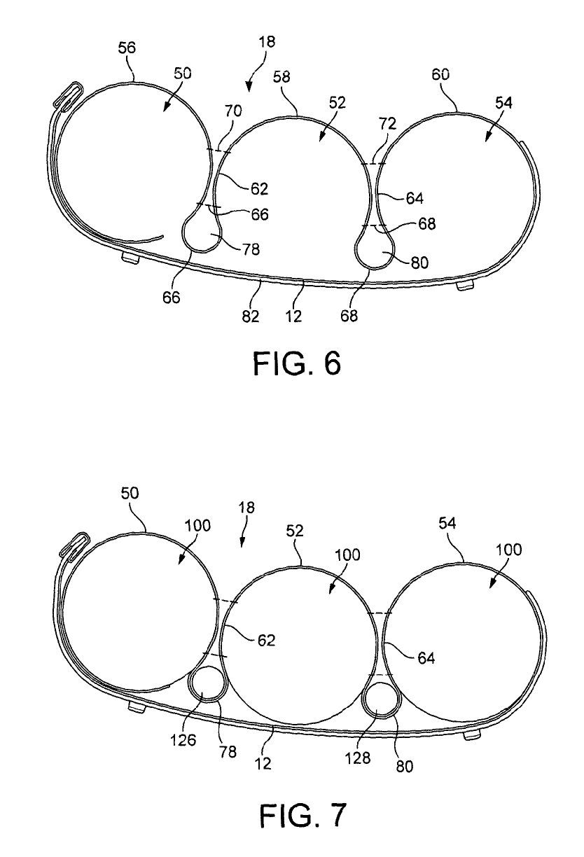

FIG. 6 schematically shows a cross-sectional view through the harness with the cylinders and conduits removed; and

FIG. 7 schematically shows a cross-sectional view through the harness with the cylinders and conduits in place.

FIGS. 1 and 2 show a breathing apparatus set 1 comprising a harness 10, a plurality of cylinders of breathable gas 100 and various breathing apparatus components. In this embodiment the harness 10 is capable of supporting three cylinders of breathable gas 100 side-by-side. However, it will be appreciated that the harness 10 may be capable of supporting any suitable number of cylinders of breathable gas. The harness 10 comprises a cover 12 in the form of a flexible fabric panel that can be moved between an open configuration in which the cylinders 100 are exposed and a closed configuration (shown in FIG. 1) in which the cylinders 100 are covered. For the purposes of clarity, the cover 12 is not shown in FIG. 2.

In addition to the main cylinders of breathable gas 100, the breathing apparatus set 1 also comprises an auxiliary cylinder module 210 that is detachably attached to the harness 10. The auxiliary cylinder module 210 comprises a cylinder of breathable gas, a top housing 212, a flow control valve 214, a pressure gauge 216 and a fluid connector 218. As can be seen in FIG. 3, if necessary, the auxiliary cylinder module 210 can be completely detached from the harness 1 and can be used for rescue purposes or the like.

FIGS. 4 and 5, show the harness 10 with the cover 12 removed and without the cylinders 100. The harness 10 is arranged to be worn on the back of a user and is generally longitudinally extending in the direction of the user's back. The harness 10 comprises an upper housing 14 and a lower housing 16 that is longitudinally spaced from the upper housing 14. The upper and lower housings 14, 16 extend in a direction across the user's back that is substantially perpendicular to the longitudinal direction. The upper and lower housings 14, 16 are attached together by a longitudinally extending back member 18 which in this embodiment is a fabric panel. It should be appreciated that in other embodiments the back member 18 may be a rigid panel, a flexible panel, or a series of rigid bars, for example. The back member 18 can be attached to the upper and lower housings 12, 14 by any suitable method such as by stitching or riveting, for example.

The upper housing 14 is arranged to retain the upper ends of each cylinder 100 and the lower housing 16 is arranged to retain the lower ends of each cylinder 100. The lower housing 16 also houses other breathing apparatus components, which will be described in detail below. When the cylinders are attached to and supported by the harness 10, this results in a substantially rigid assembly with the longitudinal rigidity provided by the cylinders, and the transverse rigidity provided by the upper and lower housings 14, 16.

The harness 10 also comprises left and right shoulder straps 20, 22 and a waist belt 24 that enables the harness to be comfortably worn by a user. The waist belt 24 is pivotally attached to a plate 26 which is attached to the back member 18. The left and right shoulder straps 20, 22 are each attached at an upper end to the top housing 14 and at a lower end to the plate 26. The length of the shoulder straps 20, 22 and the waist belt 24 can be adjusted for maximum user comfort.

The fabric back member 18 defines first, second and third longitudinally extending cylinder channels 50, 52, 54 that are each arranged to accommodate a single cylinder of breathable gas. The cylinder channels 50, 52, 54 are located side-by-side and are therefore laterally spaced from one another. The cylinder channels 50, 52, 54 each have a rear wall 56, 58, 60 and first and second channel side walls 62, 64 separate the first and second cylinder channels 50, 52 and the second and third cylinder channels 52, 54 respectively. The cylinder channels 50, 52, 54 are each open along their entire length, which allows a cylinder to be easily inserted into and removed from the channel 50, 52, 54, and each channel extends between the upper and lower housings 14, 16. However, in other embodiments the cylinder channels 50, 52, 54 may only be partially open along their length.

As shown in FIG. 2, when the breathing apparatus set 1 is assembled, a single cylinder 100 of breathable gas is disposed within each of the three cylinder channels 50, 52, 54. The first and second channel side walls 62, 64 are located between adjacent cylinders 100, and therefore prevent the cylinders from coming into direct contact with one another. The upper end of each cylinder 100 is retained by the upper housing 14 and the lower end of each cylinder is retained by the lower housing 16. This results in a relatively stable low-profile set.

The arrangement and construction of the back member 18 and cylinder channels will now be described with reference to FIGS. 6 and 7.

As can be seen from FIG. 6, the back member 18, which connects the upper and lower housings 14, 16 and which defines the cylinder channels 50, 52, 54, is formed from a continuous layer of fabric and the front cover 12 is also formed from the same layer of fabric. The single continuous layer of fabric is stitched in order to form the cylinder channels 50, 52, 54 and the channel side walls 62, 64.

The fabric layer is folded back on itself along a longitudinal line, thereby forming a double layer of fabric, in order to form the first and second channel side walls 62, 64. The channel side walls 62, 64 are therefore approximately perpendicular to the rear walls 56, 58, 60 of the cylinder channels. The fold forms a forward-facing edge 66, 68, or side, of each of the side walls 62, 64. Each double layer of fabric which forms a channel side wall 62, 64 is stitched along a first longitudinally extending line 70, 72 that is between the channel side wall 62, 64 and an adjacent pair of rear walls 56, 58; 58, 60 in order to stitch the two layers together. This forms the base of the channel side wall 62, 64. Each double layer of fabric which forms a channel side wall 62, 64 is also stitched along a second longitudinally extending line 74, 76 that is rearward of the forward-facing edge 66, 68 in order to stitch the two layers together. The stitching along the second longitudinally extending lines 74, 76 forms first and second conduit retainer channels 78, 80 that are longitudinally extending and coextensive with the channel side walls 62, 64. In this particular embodiment the conduit retainer channels 78, 80 are closed along their length and are open at first and second ends. However, it should be appreciated that the retainer channels could be partially open, or openable, along their length. In order to increase the rigidity of the cover 12, an additional fabric panel 82 is stitched to the cover 12. The cover 12 extends across the front of the cylinder channels 50, 52, 54 and can be secured to the back member 18 by Velcro ® or the like. In order to access the cylinder channels 50, 52, 54, the cover can be detached from one side of the back member 18 and folded to an open configuration in which the channels 50, 52, 54 are exposed.

FIG. 7 shows the harness 10 supporting three cylinders of breathable gas 100 with a single cylinder located in each of the three cylinder channels 50, 52, 54. As can be seen, each of the cylinders is securely held in the respective channel 50, 52, 54 between the rear walls 56, 58, 60, the side walls 62, 64 and the cover 12. Importantly, a channel side wall 62, 64 is disposed between each adjacent cylinder 100 along their entire length and therefore adjacent cylinders 100 are prevented from coming into contact with one another. This prevents any potential damage that may be caused by friction between adjacent cylinders. In one arrangement the outermost layer of the cylinders comprises carbon-fibre which may be susceptible to frictional damage. Therefore, the fabric channel side walls 62, 64 prevent abrasion of adjacent carbon-fibre layers.

A longitudinally extending conduit 126, 128 is located within each conduit retainer channel 78, 80 in front of the cylinders. As best seen in FIG. 2, the two conduits 126, 128 longitudinally extend from the interior of the lower housing 16 up the harness within the conduit channels 78, 80 to the upper housing 14. The conduits 126, 128 extend to positions on the left and right shoulder straps 20, 22. In this embodiment, one of the conduits is an electrical conduit 126 that shrouds electrical cables such as power and signal cables, and the other conduit is a medium-pressure conduit 128 which supplies medium-pressure breathable air from the cylinders to the user. It should be appreciated that in other embodiments one or both conduits may be electrical or hydraulic and there may be any suitable number of conduits. The conduit retainer channels 78, 80 retain the conduits 126, 128 in a predetermined position and prevent them from becoming loose and presenting a snagging hazard.

The conduits 126, 128 retained within the conduit retainer channels 78, 80 provided by the channel side walls 62, 64 also provide another important benefit. The diameter of the conduits 126, 128 is greater than the gap between adjacent cylinders 100 and therefore the conduits 126, 128 prevent, or at least inhibit, the withdrawal of the channel side walls 62, 64 from between adjacent cylinders. The conduits 126, 128 therefore act as retaining means to prevent the channel side walls from becoming displaced from between adjacent cylinders.

Although it has been described that the conduit retainer channels 78, 80 are closed along their length and are coextensive with the side walls 62, 64, in other embodiments the retainer channels 78, 80 could be openable along their length. For example, the retainer channels 78, 80 could be provided with a Velcro ® seam or with a zip that would enable the retainer channels 78, 80 to be opened so that a conduit could be easily located within the channel. Instead of a conduit retainer channel, each side wall could be provided with alternative means for attaching, or coupling, a conduit thereto. For example, each side wall 62, 64 could be provided with a number of conduit clips longitudinally spaced so that a conduit could be coupled to the side wall 62, 64 at a position in front of the cylinders.

Although it has been described that the retaining means for inhibiting the withdrawal of a side wall from between adjacent cylinders is a conduit retainer arranged to attach a conduit to the side wall, other means or arrangements could be used to inhibit the withdrawal of a side wall from between adjacent cylinders. For example, toggles, clips, straps or bands may be used to inhibit or prevent the withdrawal of a side wall from between adjacent cylinders.

As will be appreciated by one skilled in the art, the harness may comprise any suitable number of cylinder channels. For example, there may be two, three, for, five or six.

What is claimed is:

1-22. (canceled)

23. A breathing apparatus set comprising:
a harness comprising:
upper and lower longitudinally spaced housings coupled together by a longitudinally extending back member;
left and right shoulder straps;
a waist belt;
at least three longitudinally extending cylinder channels arranged side-by-side;
at least two channel side walls, each channel side wall laterally separating a pair of adjacent cylinder channels; and
at least two conduit retainers, each conduit retainer coupled to a channel side wall;
at least three cylinders of breathable gas supported by the harness and located side-by-side, the cylinders having their upper portions retained by the upper housing and their lower portions retained by the lower housing, wherein each cylinder is disposed in a respective cylinder channel with a channel side wall disposed between adjacent cylinders;
at least two conduits, each conduit fluidically coupled to a cylinder and attached to a conduit retainer at a position in front of the cylinders so as to inhibit the withdrawal of the respective channel side wall from between adjacent cylinders.

24. A harness for breathing apparatus, the harness arranged to support a plurality of cylinders of breathable gas side-by-side, the harness comprising a plurality of longitudinally extending cylinder channels arranged side-by-side, each cylinder channel having a rear wall and open at least partially along its length and arranged to accommodate a cylinder, wherein adjacent cylinder channels are laterally separated by a longitudinally extending channel side wall that in use is disposed between adjacent cylinders.

25. A harness according to claim 24, wherein the or each channel side wall is provided with a retaining means which in use is arranged to inhibit the withdrawal of the or each channel side wall from between adjacent cylinders.

26. A harness according to claim 24, wherein the or each channel side wall is provided with a conduit retainer such that in use a conduit can be attached to the channel side wall so as to inhibit the withdrawal of the channel side wall from between adjacent cylinders.

27. A harness according to claim 26, wherein the or each conduit retainer comprises a conduit retainer channel that longitudinally extends with the channel side wall and within which a conduit can be retained.

28. A harness according to claim 27, wherein the or each conduit retainer channel is coextensive with the respective channel side wall.

29. A harness according to claim 27, wherein the or each conduit retainer channel can be opened along its length so that a conduit can be inserted into and removed from the conduit retainer channel.

30. A harness according to claim 24, wherein the rear walls and/or the or each channel side wall comprises a layer of fabric.

31. A harness according to claim 30, wherein the rear walls and the or each channel side wall is formed from a continuous layer of fabric.

32. A harness according to claim 24, wherein the or each channel side wall comprises a double layer of fabric.

33. A harness according to claim 32, wherein the or each double layer of fabric is stitched together along a first longitudinally extending line between the channel side wall and an adjacent pair of rear walls.

34. A harness according to claim 32, wherein the or each double layer of fabric is stitched together along a second longitudinally extending line which is rearward of a forward-facing edge of the channel side wall.

35. A harness according to claim 24, wherein the or each channel side wall is provided with a conduit retainer such that in use a conduit can be attached to the channel side wall so as to inhibit the withdrawal of the channel side wall from between adjacent cylinders; wherein the or each conduit retainer comprises a conduit retainer channel that longitudinally extends with the channel side wall and within which a conduit can be retained; wherein the or each channel side wall comprises a double layer of fabric which is stitched together along a second longitudinally extending line which is rearward of a forward-facing edge of the channel side wall; wherein the stitching along the second longitudinally extending line forms at least part of the conduit retainer channel.

36. A harness according to claim 24, further comprising a cover that can be moved between at least a closed configuration in which in use the cylinders are covered and an open configuration in which in use the cylinders are at least partially exposed.

37. A harness according to claim 24, further comprising upper and lower longitudinally spaced housings arranged to retain upper and lower portions of each cylinder respectively, wherein the plurality of cylinder channels extend between the upper and lower housings.

38. A harness according to claim 37, wherein the upper and lower longitudinally spaced housings are coupled together by a longitudinally extending back member.

39. A harness according to claim 38, wherein the longitudinally extending back member comprises the plurality of cylinder channels.

40. A harness according to claim 39, wherein the back member comprises a layer of fabric.

41. A harness according to claim 24, wherein there are at least two, at least three or at least four cylinder channels.

42. A breathing apparatus set comprising:
a harness in accordance with claim 23; and
a plurality of cylinders of breathable gas supported by the harness, wherein each cylinder is disposed in a cylinder channel.
